(19) United States
(12) Patent Application Publication
(10) Pub. No.: US 2017/0253007 A1
(43) Pub. Date: Sep. 7, 2017

(54) HEAD LINER FOR VEHICLE

(71) Applicants: HYUNDAI MOTOR COMPANY, Seoul (KR); KIA MOTORS CORPORATION, Seoul (KR)

(72) Inventors: Hee Sang PARK, Seoul (KR); Dae Ig JUNG, Suwon-si (KR); Seok Jun YONG, Hwaseong-si (KR); Kwang Min PARK, Cheongju-si (KR); Il No LEE, Cheongju-si (KR); Choong Ho KWON, Seoul (KR); JangSeok PARK, Incheon (KR)

(73) Assignees: HYUNDAI MOTOR COMPANY, Seoul (KR); KIA MOTORS CORPORATION, Seoul (KR)

(21) Appl. No.: 15/337,868

(22) Filed: Oct. 28, 2016

(30) Foreign Application Priority Data
Mar. 4, 2016 (KR) 10-2016-0026660

(51) Int. Cl. B32B 7/12; B60R 13/02; B32B 5/24; B32B 17/06; B32B 5/18; B32B 5/02

(52) U.S. Cl. CPC B32B 7/12; B32B 5/18; B32B 5/022; B32B 5/245; B32B 17/066; B32B 17/067; B60R 13/0212; B32B 2255/02; B32B 2255/26; B32B 2262/0284; B32B 2266/0214; B32B 2307/102; B32B 2307/31; B32B 2307/304; B32B 2605/08

(57) ABSTRACT

The present disclosure provides a headliner for a vehicle. The headliner includes a foam; a hot melt film positioned on a surface of the foam; a reinforcement sheet positioned on the hot melt film; and a heat shielding layer coated with a thermal barrier material on the reinforcement sheet. In particular, the heat shielding layer includes a carbon nanotube.

### CROSS-REFERENCE TO RELATED APPLICATION

This application claims priority to and the benefit of Korean Patent Application No. 10-2016-0026660, filed on Mar. 4, 2016, the entire contents of which are incorporated herein by reference.

### FIELD

The present disclosure relates to a headliner for a vehicle.

### BACKGROUND

The statements in this section merely provide background information related to the present disclosure and may not constitute prior art.

A headliner for the vehicle is installed at an indoor ceiling of the vehicle to prevent a noise inflowing to the indoor of the vehicle from an outside, and the headliner is made of a laminated structure of various layers to improve a thermal insulation cutting the heat transmission outside or inside the vehicle.

In general, the vehicle is enclosed by a glass such that a structure that a hot air easily inflows in the room and a cool air easily inflows in the room is formed. Particularly, when the vehicle of which most of the external is made of a metal steel sheet is stored in a sealed state in summer, an inner temperature may be rapidly increased. To reduce the temperature increase, a method inhibiting or reducing the inflow of the external hot air is applied by adhering or coating a film to the glass.

### SUMMARY

The present disclosure provides a headliner for the vehicle having improved thermal barrier performance while reducing an increasing of the weight and the volume.

According to one form of the present disclosure, a headliner for a vehicle includes: a foam; a hot melt film positioned on at least one surface of the foam; a reinforcement sheet positioned on the hot melt film; and a heat shielding layer coated with a thermal barrier material on the reinforcement sheet, wherein the heat shielding layer includes a carbon nanotube.

A glass sheet positioned between the foam and the hot melt film; and an adhesive positioned between the foam and the glass sheet may be further included.

The thickness of the heat shielding layer may be approximately 5-10 μm.

The carbon nanotube may have a diameter of approximately 10-30 nm and a length of approximately 20-40 μm.

The thermal barrier material may include the carbon nanotube of approximately 10-20wt %, poly acryl resin of approximately 5-10wt %, alcohol of approximately 65-85 wt %, and an additive of approximately 0.1-5wt % relative to a total weight of the thermal barrier material.

The foam may include at least one of polypropylene (PP), polyethylene terephthalate (PET), a rubber plywood, an open plate sound insulation sheet, a thermoplastic elastomer (TPE), ethylene propylene rubber (EPDM), ethylene vinyl acetate (EVA), CaCo₃, stearic acid, linear low density polyethylene (LLDPE), elastomer, non-woven fabric, glass wool, cork, foaming resin, felt, microfiber, or polyurethane.

The hot melt film may include at least one of polyolefine, thermoplastic elastomer (TPE;), polyethylene terephthalate (PET), polyethylene (PE), or polyamide.

The thickness of the hot melt film may be approximately 30-50 μm.

The adhesive may include an urethane adhesive.

A skin layer positioned on the heat shielding layer may be further included.

The skin layer may include at least one of a non-woven fabric, a PVC sheet, a textile, or polyurethane foam.

As described above, the headliner for the vehicle according to an exemplary form of the present disclosure including the coating layer including the carbon nanotube, thereby the thermal barrier performance is improved while reducing the weight and the volume.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a vehicle showing a positioned at which a headliner;

FIG. 2 is a cross-sectional view of a headliner;

FIG. 3 is a graph showing an experiment result of a temperature increasing degree depending on a time passing of a headliner;

FIG. 4 is a graph showing a result measuring an inner temperature depending on a time passage of a vehicle applied with a headliner;

FIG. 5 is a graph showing an experiment result of a transmittance for each wavelength of a light of a headliner;

FIGS. 6A and 6B are SEM photos of a cross sectional of a headliner according to a comparative example a and an exemplary embodiment b, respectively

FIGS. 7A-7B are photos taken a plane of a headliner according to a comparative example a and an exemplary form b, respectively;

FIGS. 8A-8B are SEM photos taken a headliner according to a comparative example a and an exemplary form b; and

FIGS. 9A-9C are photos taken a headliner manufactured according to a comparative example a and b and an exemplary form c.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As those skilled in the art would realize, the described forms may be modified in various different ways, all without departing from the spirit or scope of the present disclosure.

In order to clearly explain the present disclosure, a portion that is not directly related to the present disclosure was omitted, and the same reference numerals are attached to the same or similar constituent elements through the entire specification.

In addition, the size and thickness of each configuration shown in the drawings are arbitrarily shown for better understanding and ease of description, but the present disclosure is not limited thereto. In the drawings, the thickness of layers, films, panels, regions, etc., are exaggerated for clarity. In the drawings, for better understanding and ease of description, the thicknesses of some layers and areas are exaggerated.

In addition, unless explicitly described to the contrary, the word “comprise” and variations such as “comprises” or “comprising”, will be understood to imply the inclusion of stated elements but not the exclusion of any other elements.

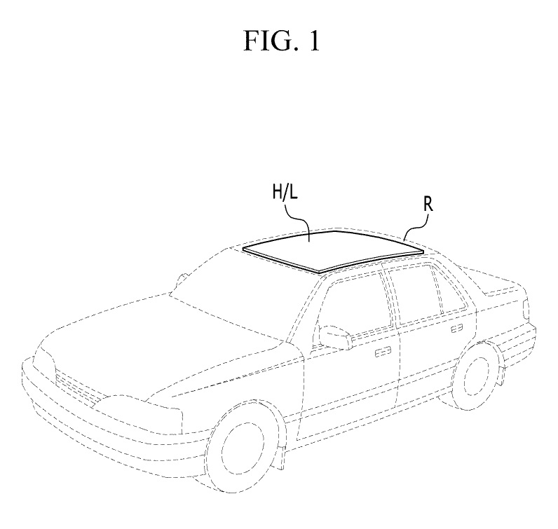

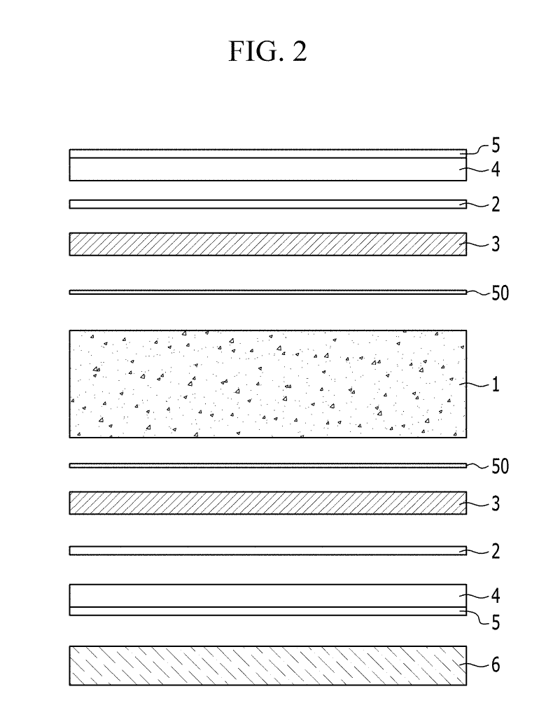

Now, a headliner for a vehicle according to one form of the present disclosure will be described in detail with reference to FIG. 1 and FIG. 2.

FIG. 1 is a perspective view of a vehicle showing a position of a headliner according to the present disclosure, and FIG. 2 is a cross-sectional view of the headliner.

First referring to FIG. 1, external factors such as a noise or a heat that may flow into the indoor of the vehicle gives a significant impact on a ride comfort sensation of a driver and a passenger. A loop panel R is positioned to be closest to a head part and having a function of a roof of the vehicle as shown in FIG. 1, and a headliner HL may be manufactured of a sheet shape to be included in the loop panel RT. The loop panel R and the headliner HL play a role for the shielding of the external factors. In that regard, a performance difference may be caused depending on a structure and a material of the headliner HL included inside the loop panel R.

Referring to FIG. 2, the headliner HL includes an adhesive layer 50 positioned on a foam 1, a glass sheet 3 positioned on the adhesive layer 50, a hot melt film 2 positioned on the glass sheet 3, a reinforcement sheet 4 positioned on the hot melt film 2, and a heat shielding layer 5 coated on the reinforcement sheet 4. The structure of the headliner may be also laminated under the foam 1.

Next, each configuration of the headliner will be described in detail.

The foam 1 as a foaming material, particularly to obtain a sound insulation effect, may include at least one among polypropylene (PP), polyethylene terephthalate (PET), a rubber plywood, an open plate sound insulation sheet, a thermoplastic elastomer (TPE), ethylene propylene rubber (EPDM), ethylene vinyl acetate (EVA), CaCo₃, stearic acid, linear low density polyethylene (LLDPE), elastomer, non-woven fabric, glass wool, cork, foaming resin, felt, microfiber, and polyurethane, however it is not limited thereto.

The foam 1 may be in a form of a single layer or two or more multi-layered structure.

A weight of the foam 1 may be 1,000-1,100 g/m², and a thickness thereof may be 4-10 mm.

The adhesive layer 50 to mutually adhere the glass sheet 3 to the foam 1 may be an urethane adhesive, however it is not limited thereto.

The glass sheet 3 adhered on the foam 1 through the adhesive layer 50 may serve as a function of inhibiting or preventing a tear due to an external impact on the headliner.

The hot melt film 2 positioned on the glass sheet 3 is melted and pressed between the glass sheet 3 and the reinforcement sheet 4, thereby serving as a function adhering the glass sheet 3 and the reinforcement sheet 4.

The hot melt film 2 may include a material having a fast drying time and capable of being adhered for several materials, for example, may include at least one among polyolefine, thermoplastic elastomer (TPE;), polyethylene terephthalate (PET), polyethylend (PE), and polyamide, however it is not limited thereto.

The thickness of the hot melt film 2 may be 30-50 μm.

The reinforcement sheet 4 positioned on the hot melt film 2 may be a non-woven fabric and may include polyethylene terephthalate (PET).

The heat shielding layer 5 formed by coating the thermal barrier material is positioned on at least one surface of the reinforcement sheet 4 according to one form of the present disclosure.

The thermal barrier material may include a carbon nanotube, and the carbon nanotube may be a multi-walled carbon nanotube.

In this case, the carbon nanotube may have a diameter of 10-30 nm and a length of 20-40 μm, and the carbon nanotube may be experienced with a surface reformation process through an acid treatment. This is because a degree of a dispersion of the carbon nanotube is improved such that a thermal resistance is increased.

In general, the reinforcement sheet 4, which is formed of the non-woven fabric having low inner surface area, and the heat shielding layer 5 which includes the carbon nanotube have a coupling force such that it is difficult that the heat shielding layer 5 is uniformly formed on the surface of the reinforcement sheet 4.

However, in the headliner according to the present disclosure, as described above, as the hot melt film 2 is melted and pressed to the reinforcement sheet 4, a coating layer is formed on the surface of the heat shielding layer 5 such that the coupling force between the heat shielding layer 5 and the reinforcement sheet 4 may be increased.

Also, the thermal barrier material may include poly acryl resin, an alcohol, an additive as well as the carbon nanotube.

The carbon nanotube of the 10-20wt % for the total weight of the thermal barrier material, the poly acryl resin of 5-10wt % for the total weight of the thermal barrier material, the alcohol of the 65-85wt % for the total weight of the thermal barrier material, and the additive of 0.1-5wt % for the total weight of the thermal barrier material may be included, respectively.

The heat shielding layer 5 may have the thickness of 5-10 μm. When the thickness is less than 5 μm, the thermal barrier may be slight. If the thickness is more than 10 μm, the volume or the weight may be increased, however the improvement degree of the thermal barrier effect is little compared with the thickness of 5-10 μm.

A skin layer 6 may be additionally positioned on the heat shielding layer 5. The skin layer 6 may be selected from a non-woven fabric, a PVC sheet, a textile, polyurethane foam. Two or more materials may be formed of a shape that the polyurethane foam is combined on the textile, however the skin layer 6 may be omitted if desired.

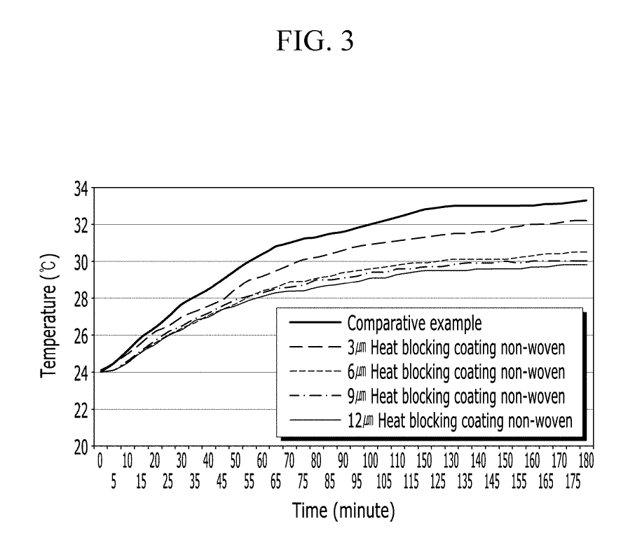

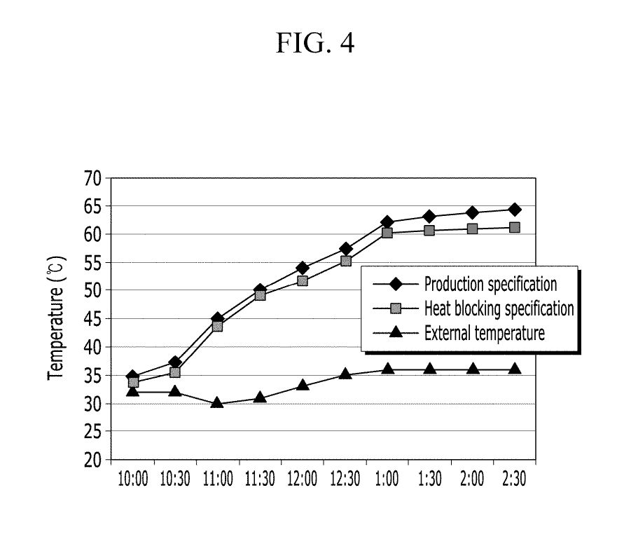

Referring to FIG. 3 and FIG. 4, an experiment result for a performance of the headliner for the vehicle will be described.

FIG. 3 is a graph showing an experiment result of a temperature increase of a headliner depending on a time passage and a comparative example, and FIG. 4 is a graph showing a result measuring an inner temperature depending on a time passage of a vehicle applied with a headliner according to one form of the present disclosure and a comparative example.

To measure the thermal barrier performance of the headliner according to the present disclosure, as an exemplary form, the carbon nanotube as the thermal barrier material is coated with the thicknesses of 3 μm, 6 μm, 9 μm, and 12 μm on the reinforcement sheet including polyethylene terephthalate (PET), respectively, as a comparative example, the reinforcement sheet including polyethylene terephthalate without the thermal barrier material is used, and a temperature change depending on a time is measured, respectively.

In the graphs of FIG. 3 and FIG. 4, a horizontal axis represents the time and a vertical axis represents the temperature.

First, as shown in FIG. 3, the temperature increasees by approximately 3° C. or less. Based on the comparison as shown in FIG.3, the thermal barrier effect of 6 μm thickness of the thermal barrier is more excellent than 3 μm thickness. However, in the case of the thickness exceeding 6 μm, the increase of the thermal barrier effect is slight.

Next, as shown in FIG. 4, when the headliner is applied to the vehicle, the temperature increase is approximately 3° C. or less.

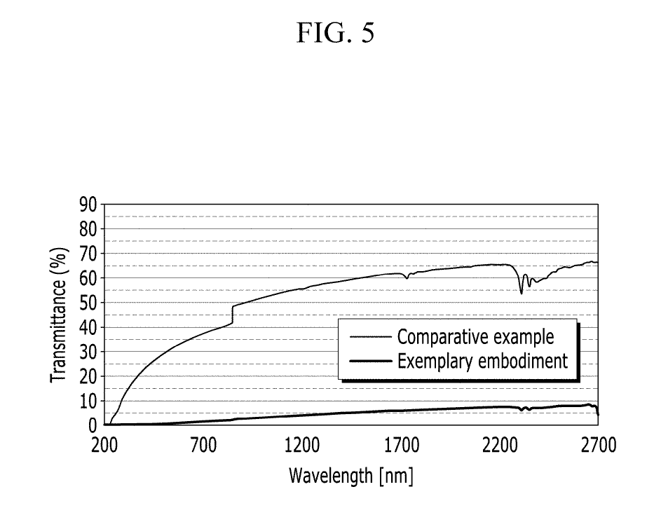

FIG. 5 is a graph showing an experiment result of a transmittance for each wavelength of a light of a headliner according to a comparative example and an exemplary form of the present disclosure.

To measure the transmittance for each wavelength of the light, as the exemplary form, the headliner in which the carbon nanotube as the thermal barrier material is coated with the thickness of 6 μm on one surface of the reinforcement sheet including polyethylene terephthalate (PET) is used. And, as the comparative example, the poly ethylene terephthalate reinforcement sheet without the thermal barrier material is used, and the transmittance of light in an infrared wavelength region is measured by using Jasco V-670 as a measuring device.

In the graph of FIG. 5, the horizontal axis represents the wavelength of light and the vertical axis represents the transmittance of light.

As shown in FIG. 5, a light blocking rate of about 30% appears in the infrared wavelength region in the case of the comparative example, however in the case of the one form of the present disclosure, the light blocking rate of 90% appears in the infrared wavelength region.

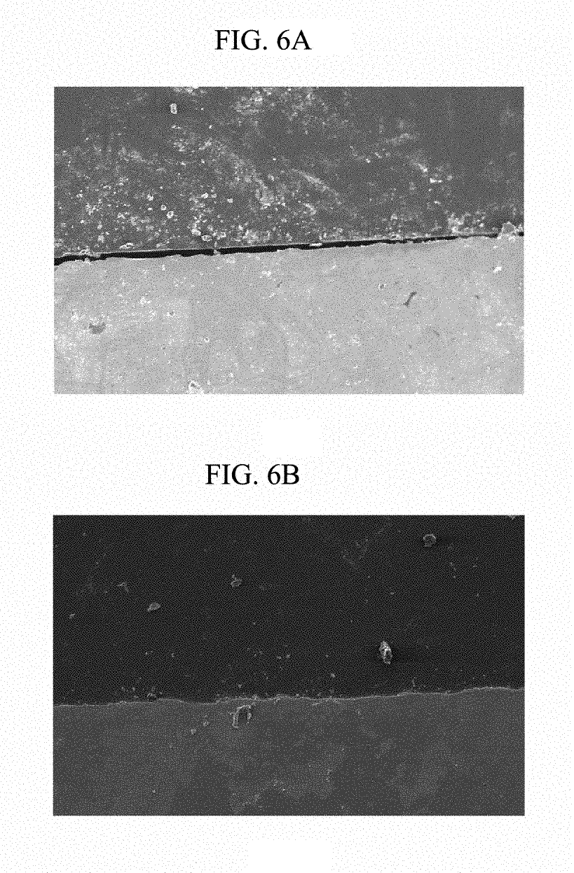

Next, the experiment result measuring a defect degree of the reinforcement sheet and the thermal barrier material of the headliner according to an exemplary form of the present disclosure will be described with reference to FIG. 6 to FIG. 8.

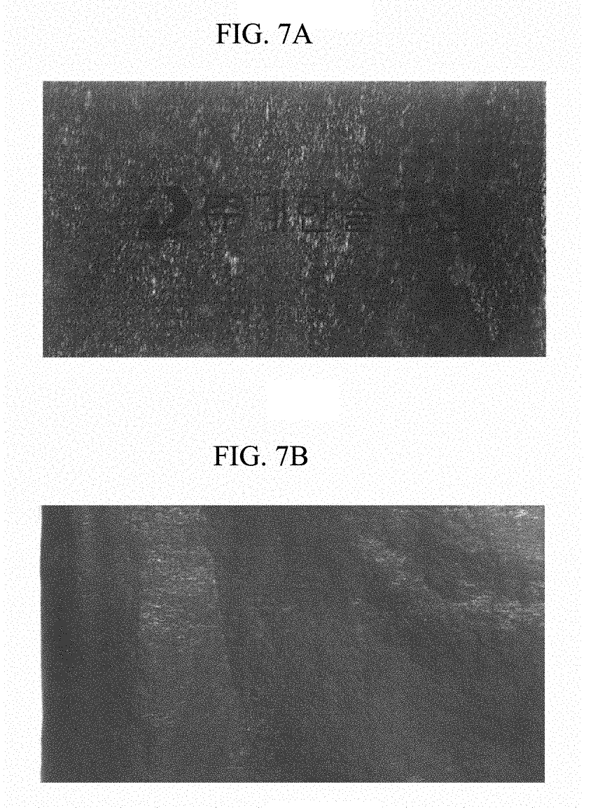

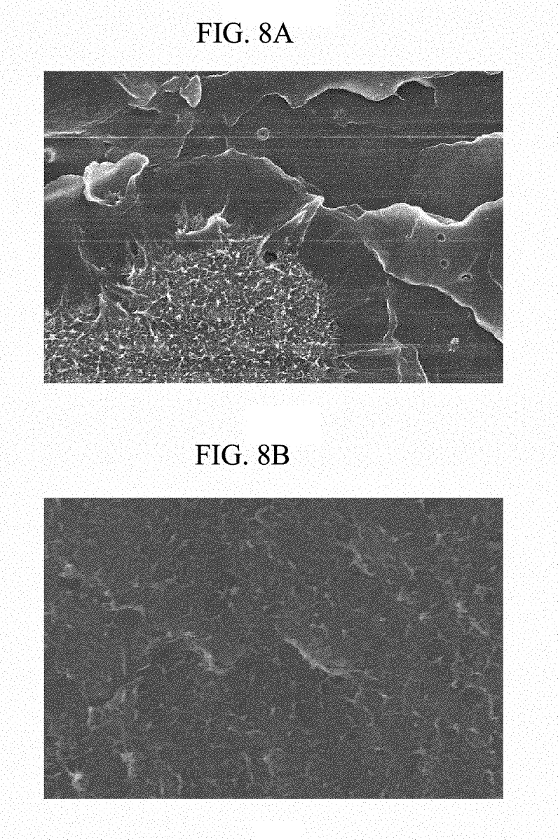

FIGS. 6A and 6B are SEM photos of a cross sectional of a headliner according to a comparative example “a” and an exemplary form “b” of the present disclosure, respectively. FIGS. 7A and 7B are photos taken a plane of a headliner according to comparative examples “a” and “b”. In addition, FIGS. 8A and 8B are SEM photos taken a headliner according to a comparative example “a” and an exemplary form “b” of the present disclosure.

To measure the defect degree of the reinforcement sheet and the thermal barrier material, as the exemplary form of the present disclosure, the headliner is coated with the hot melt film and the carbon nanotube. In particular, the hot melt film including polyethylene, is coated on one surface of the reinforcement sheet including polyethylene terephthalate (PET), and the carbon nanotube as the thermal barrier material is coated on the other surface, with each thickness of 6 μm. Whereas as the comparative example, the headliner is coated only with the thermal barrier material on the reinforcement sheet without the hot melt film coating.

As shown in FIGS. 6A and 6B, in the case of the headliner according to the comparative example, a space in FIG. 6A may be generated between the reinforcement sheet and the heat shielding layer such that the coupling force is decreased. By contrast, in the case of the headliner according to the present disclosure, the reinforcement sheet and the heat shielding layer in FIG. 6B may be uniformly coupled each other due to the adherence of the hot melt film.

Also, as shown in FIGS. 7A-7B and FIGS. 8A-8B, unlike the comparative example in which the hot melt film is omitted, the present disclosure including the hot melt film may provide the thermal barrier material which is uniformly dispersed.

Accordingly, in the case of the reinforcement sheet coated with the thermal barrier material, when the hot melt film added, the coupling force between the thermal barrier material and the reinforcement sheet may be improved and the uniform coating is possible.

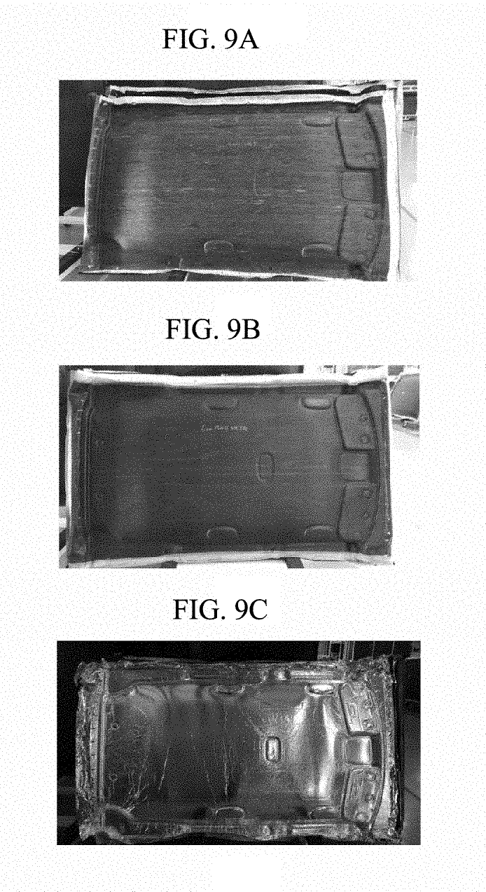

FIGS. 9A-9B are photos taken a headliner of comparative examples “a” and “b,” respectively, and FIG. 9C is a photo of a headliner of an exemplary form “c” of the present disclosure.

The comparative example “a” is manufactured the headliner in which the thermal barrier material is not coated, and the comparative example “b” is manufactured with the headliner in which an aluminum (Al) film is deposited on the reinforcement sheet.

The exemplary form “c” is manufactured with the headliner coated with the hot melt film and the carbon nanotube. More specifically, the hot melt film including polyethylene (PE) is coated on one surface of the reinforcement sheet including polyethylene terephthalate (PET), and the carbon nanotube as the thermal barrier material is coated on the other surface, with 6 μm coating thickness for each coating as pictured.

As shown in FIGS. 9C, the headliner according to one form of the present disclosure may be manufactured with the shape that may be applied to the vehicle and there is no problem of the moldability and the appearance compared with the comparative example.

As described above, the headliner for the vehicle according to the present disclosure includes the coating layer including the carbon nanotube, thereby the thermal barrier performance is improved while reducing the increase of the weight and the volume.

While this present disclosure has been described in connection with what is presently considered to be practical exemplary forms, it is to be understood that the present disclosure is not limited to the disclosed forms, but, on the contrary, is intended to cover various modifications and equivalent arrangements included within the spirit and scope of the present disclosure.

<Description of symbols>

| | |
|---|---|
| 1: foam | 50: adhesive layer |
| 3: glass sheet | 2: hot melt film |
| 4: reinforcement sheet | 5: heat shielding layer |
| 6: skin layer | HL: headliner |
| R: loop panel | |

What is claimed is:

1. A headliner for a vehicle comprising:
a foam;
a hot melt film positioned on a surface of the foam;
a reinforcement sheet positioned on the hot melt film; and
a heat shielding layer coated with a thermal barrier material on the reinforcement sheet,
wherein the heat shielding layer includes a carbon nanotube.

2. The headliner of claim 1, further comprising
a glass sheet positioned between the foam and the hot melt film; and
an adhesive positioned between the foam and the glass sheet.

3. The headliner of claim 2, wherein a thickness of the heat shielding layer is approximately 5-10 μm.

4. The headliner of claim 3, wherein the carbon nanotube has a diameter of approximately 10-30 nm and a length of approximately 20-40 μm.

5. The headliner of claim 3, wherein the thermal barrier material includes the carbon nanotube of approximately 10-20wt %, poly acryl resin of approximately 5-10wt %, alcohol of approximately 65-85wt %, and an additive of approximately 0.1-5wt % relative to a total weight of the thermal barrier material.

6. The headliner of claim 2, wherein the foam includes at least one of polypropylene (PP), polyethylene terephthalate (PET), a rubber plywood, an open plate sound insulation sheet, a thermoplastic elastomer (TPE), ethylene propylene rubber (EPDM), ethylene vinyl acetate (EVA), CaCo₃, stearic acid, linear low density polyethylene (LLDPE), an elastomer, a non-woven fabric, a glass wool, cork, foaming resin, felt, a microfiber, or polyurethane.

7. The headliner of claim 6, wherein the hot melt film includes at least one of polyolefine, thermoplastic elastomer (TPE;), polyethylene terephthalate (PET), polyethylene (PE), or polyamide.

8. The headliner of claim 7, wherein a thickness of the hot melt film is approximately 30-50 μm.

9. The headliner of claim 7, wherein the adhesive includes an urethane adhesive.

10. The headliner of claim 2, further comprising a skin layer positioned on the heat shielding layer.

11. The headliner of claim 10, wherein the skin layer includes at least one of a non-woven fabric, a PVC sheet, a textile, or a polyurethane foam.
